(19) United States
(12) Patent Application Publication
(10) Pub. No.: US 2012/0244514 A1
(43) Pub. Date: Sep. 27, 2012

(54) APPARATUS AND METHOD FOR GUIDING PEOPLE WITH ATTENTION DEFICIT

(76) Inventor: Joanne Duquette, Sherbrooke (CA)

(21) Appl. No.: 13/512,434

(22) PCT Filed: Dec. 9, 2010
(86) PCT No.: PCT/CA10/01931

§ 371 Date: May 29, 2012

Related U.S. Application Data
(60) Provisional application No. 61/285,296, filed on Dec. 10, 2009.

(51) Int. Cl. B43L 1/00

(52) U.S. Cl. 434/408

(57) ABSTRACT

An apparatus and a method for guiding tool for a user, the apparatus comprising an organiser comprising a number of activity display zones each corresponding to a category of activities; activity tokens representing activities selected in n categories, each activity display zones receiving for display activity tokens representing activities selected in a corresponding category; an a number of score tokens corresponding to a number of points. The user places, on each activity display zone, activity tokens representing activities selected in the corresponding category, the activity display zones displaying their respective activities tokens forming, for the user, a visual representation of target activities and tracking means of activities actually performed, in each category, of points earned and lost by the user, and of benefits to the user, as a result.

### FIELD OF THE INVENTION

The present invention relates to attention deficit. More specifically, the present invention is concerned with an apparatus and method for guiding people with attention deficit.

### BACKGROUND OF THE INVENTION

Attention deficit disorder (ADD) has been identified as a neurological and genetic condition resulting in a difficulty to engage upon request into life activities, in which the performance, eagerness to act and the energy of the individual are determined only by a transient sense of interest, challenge, novelty and sometimes urgency, of the individual (Paul Wender, in ADHD in Children and in Adults (2000)). While symptoms may appear to be innocent and merely annoying nuisances to observers, “if left untreated, the persistent and pervasive effects of ADHD symptoms can insidiously and severely interfere with one's ability to get the most out of education, fulfill one's potential in the workplace, establish and maintain interpersonal relationships, and maintain a generally positive sense of self.” (Ramsay, J. Russell. Cognitive Behavioral Therapy for Adult ADHD. Routledge, 2007).

Attention-deficit hyperactivity disorder or ADHD is a common childhood illness that can be treated. It is a health condition involving biologically active substances in the brain. ADHD may affect certain areas of the brain that allow problem solving, planning ahead, understanding others' actions, and impulse control.

A number of parameters can be used to assess the state of persons having ADD, including for instance their energy level, their capacity to concentrate exclusively on one single thing (hyperfocus), their transition time from one activity to a successive one, their level of attitude control. In case of a high energy level, the persons are able to direct attention, whereas with a medium energy level the persons typically need to move and proceed to something else, and with a low energy level the persons need rests. Hyperfocus may be evidence of an interest or strength, but it may also be a negative stimulus. The person may need time to go from one step or stage to a successive one. The person may have a random mood or a tendency to rumination.

Adolescence, for example, may be a period in life when a person has increased difficulty in focusing attention. Studies have shown that teenagers generally commit themselves in an activity when their interest is aroused, when they find the activity challenging or competitive, when they have a sense of doing something new, or in case of urgency or in situations of crisis, for example at the last minute before a deadline.

Attention difficulties are generally dealt with through medication. Alternatively, methods for increasing attention and driving activity are being developed.

### SUMMARY OF THE INVENTION

More specifically, in accordance with the present invention, there is provided a guiding tool for a user, comprising an organiser comprising a number n of activity display zones, each activity display zone corresponding to a category of activities; activity tokens, comprising activity tokens representing activities selected in n categories, each activity display zones receiving for display activity tokens representing activities selected in a corresponding category; an a number of score tokens, each score tokens corresponding to a number of points; wherein the user places, on each activity display zone, activity tokens representing activities selected in the corresponding category, the activity display zones displaying their respective activities tokens forming, for the user, a visual representation of target activities and tracking means of activities actually performed, in each category, of points earned and lost by the user, and of benefits to the user, as a result.

There is further provided a method for training a user, comprising: a) identification of a number of aptitudes, qualities and skills; b) for each one of the identified aptitudes, qualities and skills, selecting, in lists of activities, target activities the user commits to perform; c) selecting a number of negotiable activities; d) selecting a number of non negotiable activities; e) selecting a number of reward activities; f) determining a number of points associated with each activity selected in steps b) to e); g) counting, at every predetermined interval, a total number of points earned and lost by the user as a result of activities the user actually performed and actually missed performing, by: adding points associated with target activities performed by the user during the predetermined interval; subtracting points associated with target activities unperformed by the user during the predetermined interval; subtracting or adding points associated with negotiable activities performed by the user during the predetermined interval; and subtracting points associated with non negotiable activities performed by the user during the predetermined interval; h) when the total number of points is positive, granting the user a corresponding number of score tokens; when the total number of points is negative, taking away from the user a corresponding number of score tokens; i) when the user has at least a predetermined minimum of points in store, represented by score tokens, allowing the user to exchange a number of score tokens for a reward activity; and j) repeating steps a) to i) periodically; herein the step b) comprises, selecting, for each one of the identified aptitudes, activities that reinforce the aptitude in a identified field; selecting, for each one of the identified qualities, activities that involve the quality in a identified field; and selecting, for each one of the identified skills, activities that put the skill to contribution in a identified field.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 shows a device according to an embodiment of an aspect of the present invention;

FIG. 2 shows tokens to be used with the device of FIG. 1;

FIG. 3 shows the device of FIG. 1 as used during a method according to an embodiment of an aspect of the present invention; and

FIG. 4 shows score tokens as used during a method according to an embodiment of an aspect of the present invention.

### DESCRIPTION OF EMBODIMENTS OF THE INVENTION

There is generally provided a guiding and coaching tool and method for treating attention deficit. Attention deficit may include learning difficulties at school for example; behavioural difficulties such as tendency to skip doing certain things, anxiety, aggressiveness, disobedience etc; lack of interest, low action capacities, bad habits, inefficiency, etc.

In the case of teenagers for example, the present device and method lead them into achieving goals, by allowing them alternative ways to do things: the focus is put more on what is performed than on how it is performed, meaning that they are allowed to choose way that suit them. By building on ways that work for them, the present method and device provide that they achieve the goals, when usually many aspects of daily life that most people take for granted are rendered more difficult for them. The present method and device comprise providing elements of solution to the user, by improving the way information is conveyed to the user, offering the user assistance, offering alternatives to how the user is appraised, for example how a pupil is evaluated at school.

The present method and device provide that the user feels supported and feels he/she is part of the process. Moreover they allow that the user sets and understands the process steps and that the user is engaged in the process. The present method and device use incentives, retroaction and guidance, as well as ideas and self-knowledge originating from the user. They allow the user to discover and develop his/her own assets.

The device of the present invention provides a visual concrete reminder of selected targets and rules, in a friendly way, as well as of achievements and possible benefits or rewards.

The present method and device allow developing and valuing aptitudes, qualities and skills. By means of activities selected, for example, with a supervisor, the user learns to meet a commitment by performing predetermined activities. The activities are typically categorized into different groups, including one group of activities that give way to points if timely performed, another group of activities that comprise negotiable activities, i.e. activities that can be performed by redeeming points, such as for example watching the television or using the computer for a video game. Another group of activities may comprise non negotiable and non desirable activities, such as, for example, showing disrespect to a person, which, if performed by the user, cost him/her points. Accumulated points may be used by the user to reward himself/herself with additional activities, such as getting a new book or being taken to the restaurant for example.

The present method and device achieve drawing the attention of the user and improving the users operating capacities and getting the user used to good habits, by using what works for him/her and building on his/her assets and self esteem.

The method and device evolve with the aptitudes, skills and qualities at stake. More than one user can be involved simultaneously.

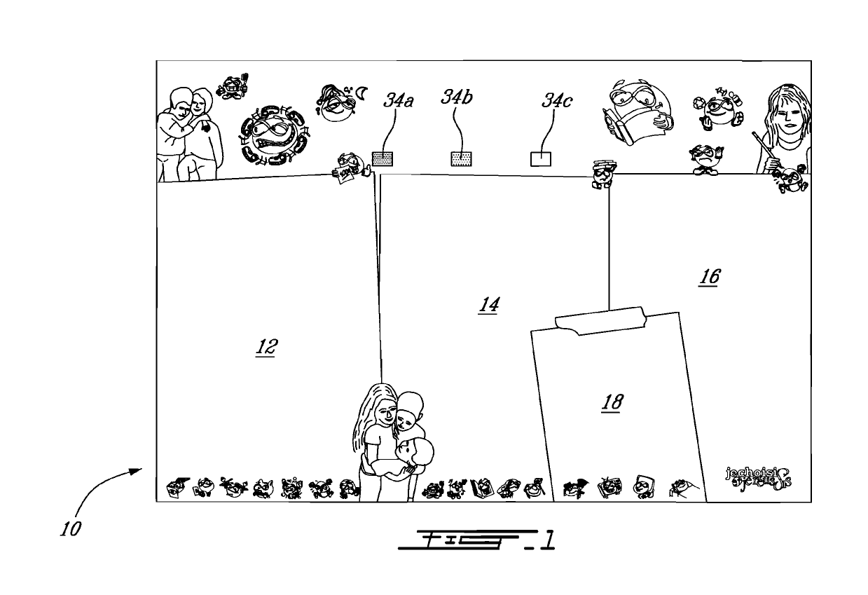

As shown for example in FIG. 1, a visual organiser, such as a magnetic board 10 for example, comprises a number of display zones 12, 14, 16, 18. Each zone corresponds to a category of activities as described hereinabove. A first category (Group A) may include activities associated with score tokens. A second category (Group B) may include negotiable activities, i.e. activities that are allowed providing the user pays a fee for them by redeeming score tokens. A third category (Group C) may include non negotiable and non desirable activities, which, if performed, cause a loss of score tokens. Another category (Group D) may include additional activities, which can be performed as a reward in exchange of a number of score tokens.

The user determines his/her own aptitudes, qualities and skills and also determines aptitudes, qualities and skills to be worked on. The user then determines, in a list of activities of Groups A-D described hereinabove, activities, associated with the aptitudes, qualities and skills to be worked on, which he/her commits to fulfil. For each target aptitudes, qualities and skills that the user has determined, the user selects at least one activity from Group A. A given activity may allow developing more than one skill or aptitude and to enhance more than one quality. For example, feeding the cat may be an activity allowing developing the aptitude identified as assuming responsibility and simultaneously the skill identified as taking care of pets. A field book may be used by the user, to take note of his/her own aptitudes, qualities and skills and also determines aptitudes, qualities and skills to be worked on and of the activities he selects.

A supervisor may be useful. Participation of the user in the determination steps allows the user to be aware of his/her potential and to reflect on himself/herself. The supervisor may be of assistance in this self-awareness by questioning the user and giving examples, inviting the user to think of answers and solutions. The supervisor may also keep track of the users targets and commitments in a field book.

The number of determined aptitudes, skills and qualities may vary from one user to another, and, for a same user, from one moment in time to another moment in time as the users condition and needs change.

An aptitude may be defined as a natural ease at doing something, for example, bargaining, convincing, decision taking, paying close attention, taking responsibility etc. A skill may be defined as an ability, either natural or learned, into an art, such as, for example, fishing, public speaking, climbing, music, sport. A quality is a characterizing way of being, such as being friendly, honest, polite, cooperative, good mixer etc.

Table I below shows an example of aptitudes, qualities and skills the user has determined.

TABLE I
My aptitudes, my skills, my qualities

| Aptitudes | Qualities | Skills |
|---|---|---|
| Comply to instructions | Cooperative | Soccer |
| Meet deadlines | Persistent | Taking care of pets |
| Understand a foreign language | Tidy | Arts |
| Assume responsibilities | Clever | |
| | Imaginative | |
| | Punctuality | |

Determination of the activities the user commits to doing takes into account the age, strength and capacities of the user for example.

For each one of the target aptitudes the user determined as being to be worked on, the user chooses activities from Group A, which may be associated with a given field such as, for example, environment, health and well-being, academic, leisure and free time, domestic, as illustrated for example in Table II below:

TABLE II
Aptitudes and activities of Group A

| to develop (Aptitudes): | I commit to (Activities) | in the field of (field) |
|---|---|---|
| Instruction compliance | switching off the lights | Environment |
| | going to bed on time | Health and well-being |
| Punctuality | being on time for meals | Health and well-being |
| | going to bed on time | Health and well-being |
| A foreign language | watching the English TV | Academics |
| | channel | |
| Sense of responsibility | feeding the cat | Domestic |
| | doing my bed | Domestic |

For each qualities the user determined as being to be worked on, the user chooses activities from Group A:

TABLE III
Qualities and activities of Group A

| to value my being | | |
|---|---|---|
| (qualities): | I commit to (Activities) | in the field of |
| cooperative | play soccer | health and well-being |
| persistent | finish a book | leisure and free time |
| | play the violin | leisure and free time |
| tidy | empty the trash bin | domestic |
| | do my bed | domestic |
| clever | get good marks at school | academic |
| Imaginative | do scrapbooking | leisure and free time |
| Punctuality | have meals on time go to bed | health and well-being |
| | on time | health and well-being |

For each skill the user determined as being to be worked on, the user chooses activities of Group A:

TABLE IV
Skills and activities of Group A

| To expand (skill) | I commit to (Activities) | in the field of (field) |
|---|---|---|
| soccer | play soccer | health and well-being |
| taking care of pets | feed the cat | domestic |
| arts | do scrapbooking | leisure and free time |

The activities selected from Group A are intended to contribute to the transformation, i.e. improvement, expansion and valuation, of the user's aptitudes, skills and qualities. One given activity may act on more than one skill or one aptitude or one quality.

Negotiable activities, i.e. activities that are allowed providing the user pays a fee for them by redeeming points, are also determined. How much the user must pay for each of them is to be decided by the supervisor.

TABLE V
Activities Group B

watch a non-educative TV show during 30 minutes
play with the computer
play at a playstation

Non negotiable and non desirable activities, which, if performed, cause a loss of points, are also determined. They may include for example dangerous, unethical or illegal activities. Here again, when the supervisor may feel an important non negotiable and non desirable activity has not been listed and then points it out to the user.

TABLE VI
Activities Group C

showing disrespect
getting a warning at school
listening to loud music
talking on the phone more than 10 minutes
refusing assistance to somebody

Optional activities, which may be performed as rewards by exchanging a number of points, are also determined. The user determines activities that he/she considers as rewards. Thus the user can be rewarded for having earned points.

TABLE VII
Activities Group D

getting a reading book
getting a new non-violent video game
going to the restaurant with X

The above-described steps allow acknowledging one's strengths and assets, and setting clear targets and rules, including consequences of a behaviour or an action, and rewards,

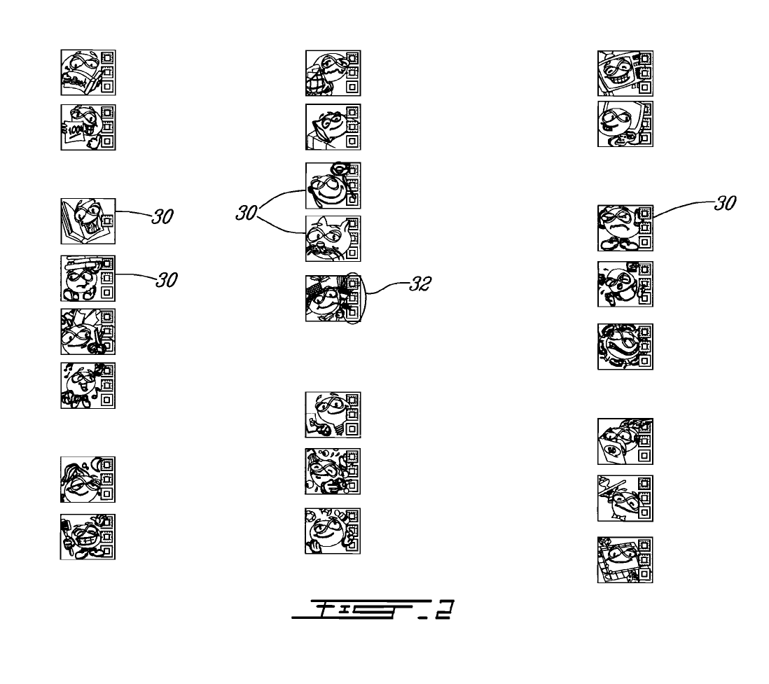

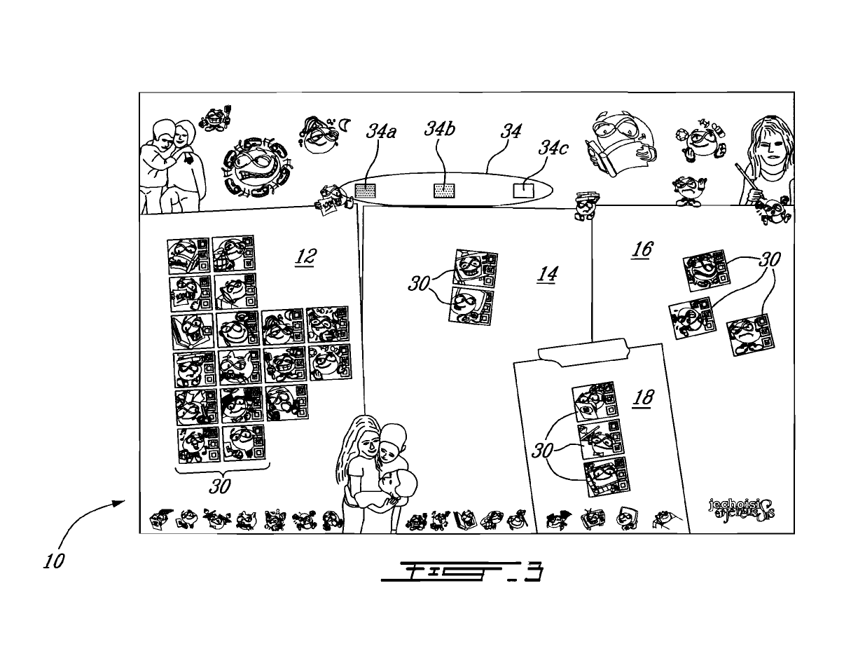

Then, in each zone 12, 14, 16, 18 of the board 10, a number of corresponding activities is displayed using activity tokens 30 as illustrated in FIG. 2 for example. FIG. 3 illustrates the board 10 with zones 12, 14, 16 and 18 each displaying a number of activity tokens 30, each activity token 30 corresponding to an activity selected as described hereinabove. In this example, the activity tokens 30 are magnetic pictograms representing an activity, such as for example, switching off lights, going to bed on time etc. Each zone 12, 14, 16 and 18 of the board 10 may have a different color for example, and the activity tokens 30 may also be of four corresponding colors, corresponding to the respective group A-D.

Each activity, selected in the groups A, B, C and D as discussed hereinabove, may be associated with a number of points, as determined by the user and the supervisor, based on the respective difficulty, impact and frequency of these activities for example. Thus, doing one's bed may be worth 5 points, whereas getting a warning at school may result in loosing 35 points. The frequency of each activity is also predetermined, since some activity, such as, for example, doing one's bed, should be done every day, while others, such as, for example playing soccer, may be done twice a week. Activities of group C and D described hereinbove may be attributed a larger number of points compared to activities of groups A and B, as determined according to the expected impact of the reward on the user and of the non-desirable activity respectively.

TABLE VIII

| Activity | Points |
|---|---|
| switching off lights | 5 |
| go to bed on time | 10 |
| have meals on time | 10 |
| watch TV channels on TV | 30 |
| feed the cat | 15 |
| get good marks at school | 40 |
| empty the trash | 35 |
| do one's bed | 5 |
| scrapbooking | 10 |
| soccer playing | 15 |
| watch a non-educative TV show during 30 | 10 |
| minutes | |
| play with the computer | 10 |
| showing disrespect | 30 |
| get a sanction at school | 35 |
| listen to too loud music | 15 |
| talk on the phone more than 10 minutes | 10 |
| refuse assistance | 25 |
| getting a reading book | 100 |
| getting a video game | 100 |
| going to the restaurant with X | 150 |

Thus the activity tokens 30 may also provide a marking area 32 (see FIG. 2), for indicating the corresponding points, using an erasable pen for example. A zone 34 on the board 10 can be dedicated as a reminder of the marking symbols (see FIG. 3): for example a dark grey marking 34a may correspond to 20 points, whereas a light grey marking 34b may correspond to 10 points and an absence of making 34c may indicate 0 point.

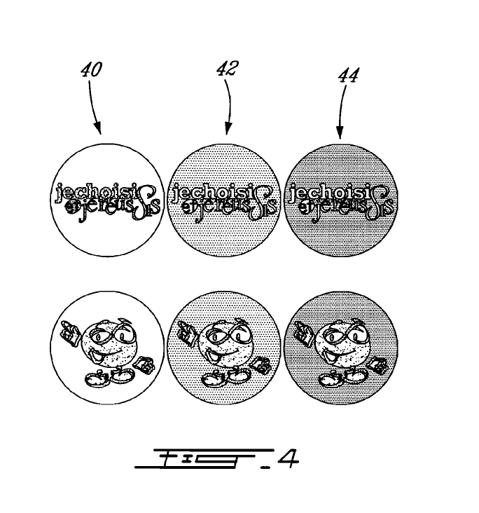

Score tokens 40, 42, 44, of different colours or shapes for example, corresponding to different amounts of points, may be used (see FIG. 4). For example, the user may initially be given a starting amount of points, in the form of a corresponding number of score tokens 40, 42 and 44, and a rule may be that he/she must always maintain this amount of points in stock. Then, the user receives a number of score tokens as he/she fulfils activities listed in zones 12, 14 and 16 of the board 10. For example, on a given day the user may make his bed (5 points), play soccer (15 points), be on time for lunch (10 points), feed the cat (15 points) and watch an English TV program (30 points) as listed on the board 10 on the one hand, and the same day, he/she goes to bed late (minus 10 points) and forgets to switch off the light (minus 5 points) one the other hand. Moreover, this same day, he/she may negotiate the right to play a non educative video game on the computer (minus 10 points). As a result, at the end of the day, the user receives score tokens for a total of 50 points, as shown in Table IX below for example:

TABLE IX
Today

| | |
|---|---|
| do one's bed | +5 points |
| soccer playing | +15 points |
| be on time for lunch | +10 points |
| feed the cat | +15 points |
| English TV | +30 points |
| go to bed on time | −10 points |
| switch off the lights | −5 points |
| play video game | −10 points (exchange) |
| TOTAL | 50 points |

Activities of Group D (zone 18 of the board 10) correspond to rewards the user can get in exchange of score tokens, provided he/she has enough in store. In the example given hereinabove, if the user already had 95 points in store, at the end of the day he/she has 145 points, and can therefore exchange 100 points to get a reading book (activity of group D), providing the balance of the points in store remains above the minimum allowed amount (see starting amount above).

The visual organiser 10 may be a magnetic board as exemplified hereinabove, with magnetic activity tokens. It may also be a poster, erasable or not, the activities being written on their respective zones or the activities being indicated on cards pinned thereto, as well as the points. A foam or cork board may be used. In case of a visual organiser 10 made in fabric, activity strips can be secured thereto using Velcro™ for example. Alternatively, the visual organiser 10 may be embodied in a computer screen.

There may be Provided a Booklet

In the case of hyperactive or defiant children or children suffering from poor attention and concentration, or moody or anxious children, use of the present device is shown to help them stay alert, self-stimulated and supported enough to complete tasks. These children are guided into learning, through selected activities, to fulfill their commitments by accomplishing activities which give them points, identified as activities of group A hereinabove, which may include, for example, doing their bed or brush their teeth. They are also taught negotiating approval of activities he wishes to do, identified as activities of group B hereinabove, which may include, for example, watching TV or playing a video game, in exchange of points. They are further faced with consequences of behaving in an unsuitable way, by loosing points in case they perform certain activities, identified as activities of group C hereinabove, which may include, for example, showing disrespect towards someone. Thanks to the points they accumulate as a result of their behavior, they are given the possibility to earn themselves rewards, identified as activities of group D hereinabove, which may include, for example, getting a new book or going to the movies.

The present tool and method allows guiding the children as their grow in age, consciousness and attention, the user and its supervisor revising and adapting the activities of groups A-D described hereinabove and the points associated therewith as the user's interests, needs and level of responsibility evolve for example.

The present tool may be used by more than one child at a time, for example by identifying the activity tokens with each one's initials.

There is thus provided a method of management and long-term treatment of attention deficit and behavioural and developmental disorders, comprising determining current capacities of the user, determining capacities to be developed or expanded or valued, and modifying behavior and lifestyle. In contrast, while medication has been shown to improve behavior when taken over the short term, it has not been shown to alter long-term outcomes.

The present invention provides a treatment for people that are easily distracted, miss details, forget things, and frequently switch from one activity to another, and/or have difficulty focusing on one thing, and/or become bored with a task after only a few minutes, unless they are doing something enjoyable, and/or have difficulty focusing attention on organizing and completing a task or learning something new, and/or have trouble completing or turning in homework assignments, often losing things (e.g., pencils, toys, assignments) needed to complete tasks or activities, do not seem to listen when spoken to, daydream, become easily confused, and move slowly, have difficulty processing information as quickly and accurately as others, struggle to follow instructions, or other troubles that they have to a degree where they significantly interfere with their work, relationships, or studies, and are disruptive in their life. The present device and method provide an operable, controllable and reproducible treatment.

Although the present invention has been described hereinabove by way of embodiments thereof, it may be modified, without departing from the nature and teachings of the subject invention as recited hereinbelow.

1. A guiding tool for a user, comprising:
an organiser comprising a number n of activity display zones, each activity display zone corresponding to a category of activities;
activity tokens, comprising activity tokens representing activities selected in n categories, each activity display zones receiving for display activity tokens representing activities selected in a corresponding category; and
a number of score tokens, each score tokens corresponding to a number of points;
wherein the user places, on each activity display zone, activity tokens representing activities selected in the corresponding category, said activity display zones displaying their respective activities tokens forming, for the user, a visual representation of target activities and tracking means of activities actually performed, in each category, of points earned and lost by the user, and of benefits to the user, as a result.

2. The tool of claim 1, wherein said organiser comprises a first activity display zone corresponding to a first category comprising activities the user commits to perform and a second category comprising activities the user commits to refrain from indulging in.

3. The tool of claim 2, wherein said activities of the first category, i) when performed by the user, give points to the user and ii) if unperformed by the user cost points to the user; and said activities of the second category, when performed by the user, cost points to the user.

4. The tool of claim 1, wherein said organiser further comprises a third activity display zone corresponding to a third category comprising negotiable activities and a fourth activity display zone corresponding to a fourth category comprising reward activities.

5. The tool of claim 1, wherein said organiser comprises a first activity display zone corresponding to a first category comprising activities the user commits to perform and a second category comprising activities the user commits to refrain from indulging in, and said organiser further comprises a third activity display zone corresponding to a third category comprising negotiable activities and a fourth activity display zone corresponding to a fourth category comprising reward activities, said activities of the third category including activities which, when performed by the user, give points to the user, and activities which, when performed by the user, cost points to the user; and said activities of the fourth category, are allowed to the user as rewards in exchange of points.

6. The tool of claim 1, wherein each activity token comprises a marking area for indicating a corresponding number of points associated therewith.

7. The tool of claim 1, wherein said organiser is a magnetic board and said activity tokens are magnetic pictograms.

8. The tool of claim 1, wherein said organiser is a writable poster and said activity tokens are one of words and pictures.

9. The tool of claim 1, wherein said organiser is a surface and said activity tokens are cards securable thereto.

10. The tool of claim 1, wherein said organiser is a digital screen and said activity tokens are icons.

11. The tool of claim 1, wherein said score tokens are of different colours corresponding to different amounts of points.

12. The tool of claim 1, wherein said score tokens are of different shapes corresponding to different amounts of points.

13. A method for training a user, comprising:
a) identification of a number of aptitudes, qualities and skills;
b) for each one of the identified aptitudes, qualities and skills, selecting, in lists of activities, target activities the user commits to perform;
c) selecting a number of negotiable activities;
d) selecting a number of non negotiable activities;
e) selecting a number of reward activities;
f) determining a number of points associated with each activity selected in steps b) to e);
g) counting, at every predetermined interval, a total number of points earned and lost by the user as a result of activities the user actually performed and actually missed performing, by: adding points associated with target activities performed by the user during said predetermined interval; subtracting points associated with target activities unperformed by the user during said predetermined interval; subtracting or adding points associated with negotiable activities performed by the user during said predetermined interval; and subtracting points associated with non negotiable activities performed by the user during said predetermined interval;
h) when the total number of points is positive, granting the user a corresponding number of score tokens; when the total number of points is negative, taking away from the user a corresponding number of score tokens; and
i) when the user has at least a predetermined minimum of points in store, represented by score tokens, allowing the user to exchange a number of score tokens for a reward activity; and
j) repeating steps a) to i) periodically;
wherein said step b) comprises, selecting, for each one of the identified aptitudes, activities that reinforce the aptitude in a identified field; selecting, for each one of the identified qualities, activities that involve the quality in a identified field; and selecting, for each one of the identified skills, activities that put the skill to contribution in a identified field.

14. The method of claim 13, comprising, for each one of the identified aptitudes, qualities and skills, selecting at least one target activity.

15. The method of claim 13, comprising, for each one of the identified aptitudes, qualities and skills, selecting at least one target activity according to the age, strength and capacities of the user.

16. The method of claim 13, wherein, in step f) each target activity is associated with a number of points, which the user earns when performing the target activity and which the user looses when missing to perform the target activity, the method comprising determining the number of points for each target activity based on a respective difficulty, impact and frequency of the target activity; each negotiable activity is associated with a number of points, which the user earns or looses when performing the negotiable activity, the method comprising determining the number of points associated with each negotiable activity based on a respective impact and frequency of the negotiable activity; each non negotiable activity is associated with a number of points, which the user looses when performing the non negotiable activity, the method comprising determining the number of points associated with each non negotiable activity based on a respective impact and frequency of the non negotiable activity; and each reward activity is associated with a number of points, which the user pays for performing the reward activity, the method comprising determining the number of points associated with each reward activity based on a respective impact of the reward activity.
